(19) United States
(12) Patent Application Publication
(10) Pub. No.: US 2015/0340132 A1
(43) Pub. Date: Nov. 26, 2015

(54) METHOD FOR SUPPLYING RESIN COMPONENTS TO WIRE HARNESS ASSEMBLY PROCESS

(71) Applicant: Yazaki Corporation, Tokyo (JP)

(72) Inventors: Masashi Kitada, Susono-shi (JP); Takahide Yamanishi, Makinohara-shi (JP); Shingo Kudou, Makinohara-shi (JP)

(21) Appl. No.: 14/747,140

(22) Filed: Jun. 23, 2015

Related U.S. Application Data
(63) Continuation of application No. PCT/JP2013/084507, filed on Dec. 24, 2013.

(30) Foreign Application Priority Data
Dec. 27, 2012 (JP) 2012-285477

(51) Int. Cl. H01B 13/012; B60R 16/02

(52) U.S. Cl. CPC H01B 13/012; B60R 16/0215

(57) ABSTRACT

More frequently used resin components of the same kinds of resin components to be assembled according to product numbers of wire harnesses are produced using a molding process in a component plant, thereby being carried into a wire harness assembly plant, a less frequently used resin component of the same kinds of resin components to be assembled according to product numbers of wire harnesses is produced using a molding process in the wire harness assembly plant, and the more frequently used resin components and the less frequently used resin components are appropriately supplied to a wire harness assembly line of the wire harness assembly plant. The more frequently used resin components are produced using an injection molding process and the less frequently used resin component is produced using a vacuum molding process or a pressure molding process.

### TECHNICAL FIELD

The present invention relates to a method for supplying resin components to a wire harness assembly process which molds the resin components such as protectors using vacuum molding or pressure molding in a wire harness assembly plant and supplies the molded resin components to a wire harness assembly line.

### BACKGROUND ART

As a conventional method for manufacturing a wire harness, for example, Patent Literature 1 discloses a method for: arranging electric wires along a wiring tool on a surface of a wire harness wiring boat while conveying a plurality of wire harness wiring boats in the form of loop along a predetermined conveyance path by a belt conveyor with an endless belt; and assembling protectors, tubes, locking clips or the like made of synthetic resin to a predetermined position of a bundle of electric wires formed of a plurality of electric wires or binding the bundle of electric wires with a tape winding. A label including an exterior inspection diagram or an attention point diagram is attached to the surface of the wire harness wiring boat.

In addition, Patent Literature 2 discloses a method for: manufacturing sub wire harnesses using a terminal making machine, an electric wire manufacturing machine, and a molding machine for molding a connector housing made of synthetic resin in a wire harness assembly plant; and forming a wire harness by assembling the plurality of sub wire harnesses to each other and assembling protectors or locking clips as a resin molded product to the assembled plurality of sub wire harnesses in an assembly line of the same wire harness assembly plant.

In addition, Patent Literature 3 discloses a method for: molding locking clips made of synthetic resin using a vertical injection molding machine installed in the vicinity of each wiring board while conveying a plurality of wiring boards along a travel route of a belt conveyor in the form of loop and arranging electric wires on each wiring board by each worker; and assembling the locking clips to a bundle of electric wires formed of a plurality of electric wires with band fastening. In addition to the locking clips, protectors made of synthetic resin or grommets made of rubber are assembled to the bundle of electric wires, thereby forming a wire harness.

In addition, Patent Literature 4 discloses a method for: forming a gutter-like protector body and a lid material for closing an elliptical opening of the protector body using vacuum molding or pressure molding in addition to injection molding as a molding method of protectors made of synthetic resin; and overlapping a bracket-like vehicle body fixing portion of the lid material and a bracket-like vehicle body fixing portion of the protector body with each other, thereby fixing both fixing portions to each other with a screw.

### CITATION LIST

### Patent Literature

Patent Literature 1: JP 2002-329429 A (FIG. 1)
Patent Literature 2: JP 2002-245876 A (FIG. 1)
Patent Literature 3: JP 2012-124090 A (FIGS. 1 and 4)
Patent Literature 4: JP 2010-93920 A (FIGS. 1 to 4)

### SUMMARY OF INVENTION

### Technical Problem

However, the conventional method for manufacturing the wire harness disclosed in Patent Literature 1 described above had the following problems, for example, as in a wire harness manufacturing process illustrated in FIG. 3 as an example, at the time of arranging (laying) electric wires on each wiring board 61 in a former wire laying process 59 while allowing the plurality of wiring boards 61 to be moved in an arrow direction from a work start position S and at the time of assembling, for example, protectors A to C as a resin component to an outer peripheral side of a bundle of electrical wires formed of the plurality of electric wires on each wiring board 61 in a latter component assembly process 60, in a wire harness assembly line 58 of a wire harness assembly plant 55.

For example, in the case where there are more frequently used common protectors A and B which are mutually used in wire harnesses A′ and B′ (not illustrated) of each type of vehicles and a less frequently used exclusive protector C which is exclusively used in a wire harness C′ (not illustrated) of a particular type of vehicle, although the common protectors A and B require a lot of quantity and the exclusive protector C requires only a small quantity, the exclusive protector C is produced in the same manner as in the common protectors A and B, packed in the same way, transported to the wire harness assembly plant 55 in the same way in a component plant 51, and should be managed as a component inventory 57 in the same way in the wire harness assembly plant 55. Accordingly, there was a problem that production costs of the wire harnesses A′ to C′ (particularly, wire harness C′) were relatively expensive.

That is, in order to produce the common protectors A and B and the exclusive protector C by an injection molding process 52 in the component plant 51, the exclusive protector C to be produced in small quantity also requires expensive molds of projecting type (core) and recessed type (cavity), so that component costs had become expensive due to high amortization of equipment or mold. In addition, since the common protectors A and B and the exclusive protector C are packed separately in the same type of packing in the component plant 51 (process indicated by reference numeral 53), packing costs (physical distribution costs) have occurred even in the exclusive protector C. Further, in order to transport the packed common protectors A and B and the exclusive protector C to the wire harness assembly plant 55 by, for example, truck (process indicated by reference numeral 54), transport costs (physical distribution costs) have occurred even in the exclusive protector C. In addition, since the exclusive protector C is produced in small quantity, for example, intervals of a transport 54 are likely to be spaced apart from each other and many days for transportation are required. Accordingly, management of timely sending the exclusive protector to the wire harness assembly plant 55 and costs required for the management were necessary.

Furthermore, in order to perform a component acceptance (process indicated by reference numeral 56) on the exclusive protector C that reached the wire harness assembly plant 55 as in the common protectors A and B and perform inventory management by storing it as the component inventory 57, an acceptance space, an inventory space, or management costs for the exclusive protector C were required. In addition, when the exclusive protector C moves to component placing yards 62 to 64 near a component assembly process 60 of a wire harness assembly line 58 from a component inventory placing yard 57 together with the common protectors A and B, since work of replenishing the exclusive protector C to the component placing yard 64 from the inventory placing yard 57 is troublesome even though only a small quantity of exclusive protector C is needed, a number of exclusive protectors C are placed in the component placing yard 64. For this reason, a space of the component placing yard 64 was tended to expand.

Even in the conventional method for manufacturing the wire harness disclosed in Patent Literature 2 or Patent Literature 3, for example, there was no method corresponding to the case where there are more frequently used common protectors (resin components) A and B which are mutually used in wire harnesses A′ and B′ (not illustrated) of each type of vehicles and a less frequently used exclusive protector (resin component) C which is exclusively used in a wire harness C′ (not illustrated) of a particular type of vehicle and there was a concern that the same problem as in Patent Literature 1 described above occurred.

The present invention has been made in consideration of the above problems and an object thereof is to provide a method for supplying resin components to a wire harness assembly process which can reduce cost of a wire harness by suppressing an increase in production cost of the wire harness caused by the less frequently used resin components, for example, when there are more frequently used resin components which are mutually used in wire harnesses of each type of vehicles and a less frequently used resin component which is exclusively used in a wire harness of a particular type of vehicle, in a wire harness assembly plant.

### Solution to Problem

In order to achieve the above object, a method for supplying resin components to a wire harness assembly process is characterized by including: producing more frequently used resin components of the same kinds of resin components to be assembled according to product numbers of wire harnesses using a molding process in a component plant, thereby being carried into a wire harness assembly plant; producing less frequently used resin components of the same kinds of resin components to be assembled according to product numbers of wire harnesses using a molding process in the wire harness assembly plant; and appropriately supplying the more frequently used resin components and the less frequently used resin components to a wire harness assembly line of the wire harness assembly plant.

With the above configuration, while the more frequently used resin components require packaging in the component plant or a transport to the wire harness assembly plant from the component plant, the less frequently used resin components are produced in the wire harness assembly plant (preferably, in the vicinity of the wire harness assembly line) in which the wire harness assembly line is disposed, so that the packaging or the transport of the less frequently used resin components is not required, the required number of less frequently used resin components can be produced as needed, and thus inventory management is not also required. The “same kinds of resin components” are different in shape or size but have the same name.

Preferably, in the method for supplying the resin components to the wire harness assembly process disclosed herein, a method for supplying resin components to a wire harness assembly process is characterized in that the more frequently used resin components are produced using an injection molding process and the less frequently used resin components are produced using a vacuum molding process or a pressure molding process.

With the above configuration, the more frequently used resin components can be produced in large quantity with the injection molding in the component plant and the required number of less frequently used resin components can be produced with a small occupancy space and as needed by the vacuum molding or the pressure molding in the wire harness assembly plant. As the resin component, a harness protector capable of the injection molding and the vacuum molding or pressure molding is suitable.

Preferably, in the method for supplying the resin components to the wire harness assembly process disclosed herein, a method for supplying resin components to a wire harness assembly process is characterized in that: the more frequently used resin components and the less frequently used resin components are disposed in each component placing yard of the wire harness assembly plant; and an identification data of a wire harness to be assembled is read out using an identification data reading apparatus in the wire harness assembly line, thereby visually displaying a component placing yard of a resin component required for an assembly and visually displaying the molding process in the wire harness assembly plant when the less frequently used resin component is required.

With the above configuration, the more frequently used resin components can be assembled to a bundle of electric wires of the more frequently used wire harness or the less frequently used resin components can be assembled to a bundle of electric wires of the less frequently used wire harness in the same wire harness assembly line. In assembling of each resin component, the assembly worker reads out the identification data of the wire harness using the identification data reading apparatus, so that the lamp of the component placing yard of each resin component is turned on to be visually displayed and the worker reliably selects a predetermined resin component from the visually displayed component placing yard and assembles the selected resin component to the bundle of electric wires of the wire harness. In the case where the less frequently used resin components are required (for example, when the assembly worker takes out one according to the visual display from the state where one or small number of the less frequently used resin components are disposed in the component placing yard), when the assembly worker reads out the identification data of the wire harness using the identification data reading apparatus, the lamp of the molding process in the wire harness assembly plant is simultaneously turned on to be visually displayed, and the worker of the molding process produces the less frequently used resin components.

In the method for supplying the resin components to the wire harness assembly process disclosed herein, a method for supplying resin components to a wire harness assembly process is characterized in that the molding process in the wire harness assembly plant is constituted by a resin plate molding machine and a vacuum molding machine or a pressure molding machine and a trimming machine, and an end material occurred by the trimming machine is recycled in the resin plate molding machine.

With the above configuration, a resin plate (sheet) is formed by a resin plate molding machine, the resin plate is subjected to the vacuum molding or the pressure molding, thereby forming an intermediate workpiece of the less frequently used resin component, and then an unnecessary part in the end of the intermediate workpiece of the resin component is subjected to trimming, thereby completing the resin component. The end material that occurred in the trimming machine is charged into the resin plate molding machine to be recycled.

### Advantageous Effects of Invention

According to the invention disclosed herein, the more frequently used resin components are produced in the component plant and the less frequently used resin components are produced in the wire harness assembly plant. Accordingly, as compared with the case of producing the less frequently used resin components in the component plant, the packaging of the less frequently used resin component or the transport to the wire harness assembly plant from the component plant thereof is not required, the required number of less frequently used resin components can be produced as needed, and thus inventory management of the less frequently used resin components is not required, so that it is possible to suppress the increase in the production cost of the wire harness due to the less frequently used resin components and to reduce the cost of the wire harness.

According to the invention disclosed herein, since the more frequently used resin components can be produced in large quantity with the injection molding in the component plant and the required number of less frequently used resin components can be produced with the small occupancy space and as needed by the vacuum molding or the pressure molding in the wire harness assembly plant, it is possible to promote the effect of the invention disclosed herein.

According to the invention disclosed herein, since the assembly worker reliably takes out each resin component from each component placing yard according to the visual display without an erroneous handling and can supply the resin component to the wire harness assembly line and the molding worker can produce the required number of less frequently used resin components as needed according to the visual display, it is possible to promote the effect of the invention disclosed herein.

According to the invention disclosed herein, when the less frequently used resin components are produced by the vacuum molding or the pressure molding in the wire harness assembly plant, the end material that occurred in the trimming is charged into the resin plate molding machine to be recycled, so that it is possible to reduce the material cost of the less frequently used resin components, thereby suppressing the increase in production cost of the wire harness due to the less frequently used resin components and reducing the cost of the wire harness.

### BRIEF DESCRIPTION OF DRAWINGS

FIG. 1 is a plan view (explanatory diagram) illustrating an embodiment of a method for supplying resin components to a wire harness assembly process according to the present invention.

FIGS. 2A to 2D are longitudinal cross-sectional views (explanatory diagrams) successively illustrating an example of a vacuum molding process of resin components.

FIG. 3 is a plan view (explanatory diagram) illustrating an embodiment of a method for supplying resin components to the conventional wire harness assembly process.

### DESCRIPTION OF EMBODIMENTS

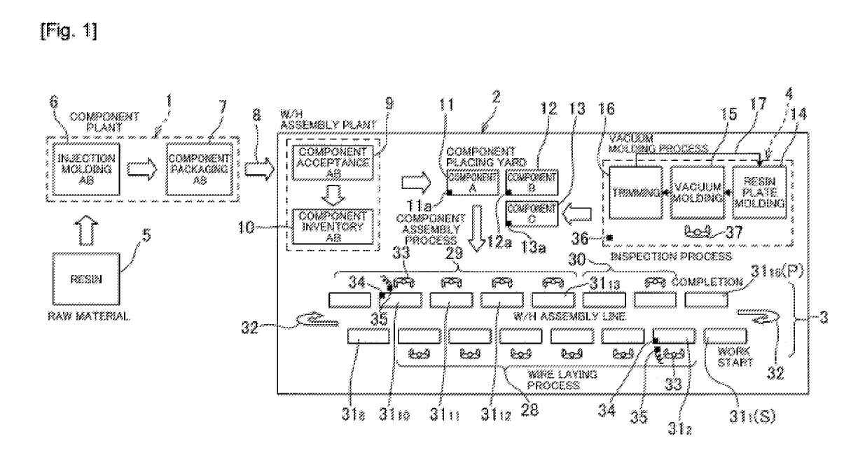

FIG. 1 illustrates an embodiment of a method for supplying resin components to a wire harness assembly process according to the present invention.

The method for supplying the resin components to the wire harness assembly process is characterized in that: two types of protectors A and B (only symbols are indicated, which are not illustrated) as common more frequently used resin components which are mutually used for wire harnesses A′ and B′ (only symbols are indicated, which are not illustrated) of, for example, each type of vehicle are produced in a large quantity at an outside component plant 1 and are carried to a wire harness assembly plant 2; and one type of protector C (only a symbol is indicated, which is not illustrated) as a less frequently used exclusive-resin component which is exclusively used for a wire harness C′ (only a symbol is indicated, which is not illustrated) of a specific type of vehicle is timely produced inside the wire harness assembly plant 2 as appropriate and is supplied to a wire harness assembly line 3 together with the common protectors A and B.

The common protectors A and B are formed by an injection molding process in the component plant 1, and the exclusive protector C is formed by a vacuum molding process or a pressure molding process in the wire harness assembly plant 2. In FIG. 1, the vacuum molding process 4 is described as an example. Each of the protectors A to C (not illustrated) is also referred to as a harness protector and includes a gutter-like protector body having a recessed cross-section and a cover having an inverted recessed cross-section for closing an elliptical opening of the protector body, or includes only a gutter-like protector body having a recessed shape, the protectors being existing ones. Each of the protectors A to C has a different shape or size but is the similar kind.

For example, a thin hinge (not illustrated) used to connect the protector body and the cover to each other or a locking portion (not illustrated) used to lock the protector body and the cover into each other can be easily formed in the case of the injection molding process for forming the common protectors A and B, but such a thin hinge or a locking portion is hardly formed in the vacuum molding process 4 or the pressure molding process.

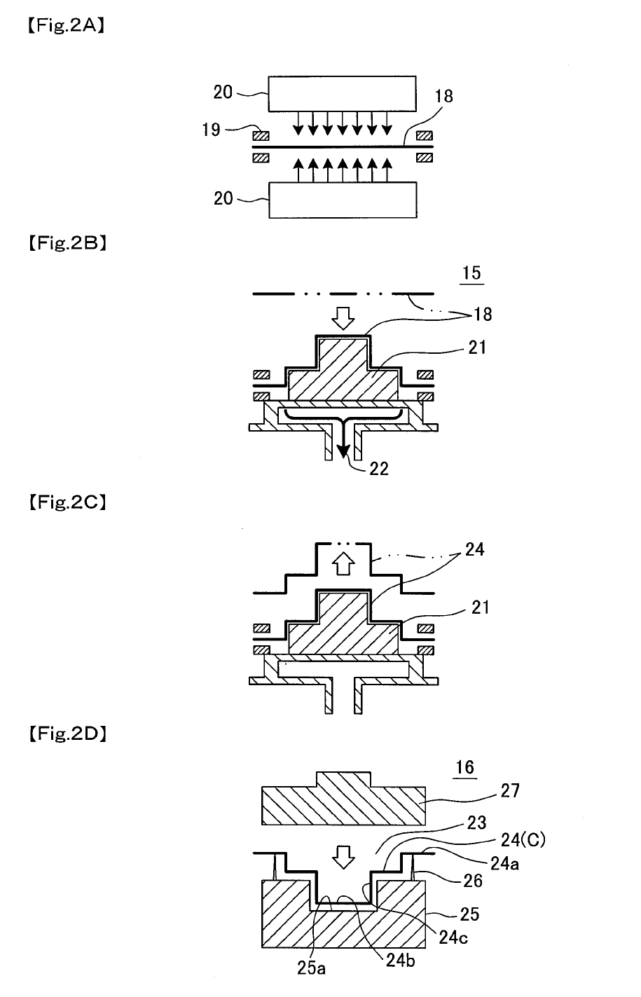

Even in the vacuum molding process 4 or the pressure molding process, however, the thin hinge may be formed using, for example, a plug assist (auxiliary type (not illustrated) for pressing the resin plate 18 (see FIGS. 2A to 2D)) during molding or the locking portion may be formed using, for example, an outer slide mold corresponding to the existing undercut or a technique such an inclined bar or a fallen pin. In the case of not forming the locking portion or the like, the protector body and the cover of the protector C can be fixed to each other by, for example, co-fastening using tape winding, bolts, clips, or the like.

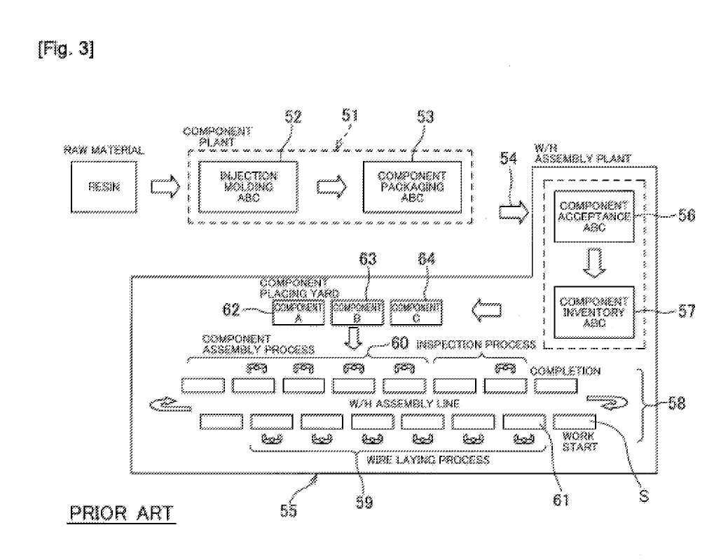

As illustrated in FIG. 1, each of the common protectors A and B is produced in such a manner that a thermoplastic resin material 5 of a raw material is injection-molded using the injection molding process 6 for each component number in the outside component plant 1, thereby being packed in each component number (process indicated by reference numeral 7), is preferably transported in a truck or the like at the same time (process indicated by reference numeral 8), and is carried to the wire harness assembly plant 2. As compared to the conventional example of FIG. 3, an expensive mold used for the injection molding of the exclusive protector C or labor and costs required for the packaging and transport of the exclusive protector C are not necessary.

The common protectors A and B carried into the wire harness assembly plant 2 are temporarily stored as a component inventory 10 through a component acceptance (including an acceptance inspection) 9 and then are transferred to component placing yards 11 and 12 near the wire harness assembly line 3.

Meanwhile, required number of exclusive protectors C is timely manufactured as needed using the vacuum molding process 4 or the pressure molding process in the wire harness assembly plant 2. The vacuum molding process 4 or the pressure molding process is made up of a vacuum molding machine 15 or a pressure molding machine installed in the vicinity of the wire harness assembly line 3, a resin plate molding machine 14 as a preceding process, and a trimming machine 16 as a subsequent process.

The resin plate molding machine 14 forms a single flat resin plate 18 (see FIGS. 2A to 2D) from a thermoplastic resin material (pellet) of a raw material which is not illustrated. That is, the resin material of the raw material is heated and melted, thereby obtaining the flat resin plate 18 using, for example, a molding method such as injection molding, extrusion molding, or roll molding. The resin plate 18 is also referred to as a sheet and is formed in a size (more properly, slightly larger than the developed shape) according to a developed shape of the exclusive protector C.

The trimming machine 16 cuts an unnecessary end of an intermediate protector workpiece formed by the vacuum molding machine 15 or the pressure molding machine and forms the exclusive protector C as a product (resin component). An unnecessary end material that occurred in the trimming process 16 is crushed into, for example, a pellet shape and then is charged into the resin plate molding machine 14 as indicated by an arrow 17 in FIG. 1 to be recycled.

An example of the vacuum molding process 4 will be described with reference to FIGS. 2A to 2D. Further, a finished shape of a molded product in FIG. 2D does not necessarily correspond to the shape of the exclusive protector C.

First, as illustrated in FIG. 2A, the flat resin plate (sheet) 18 is heated and softened using upper and lower heaters 20 in a state of being horizontally supported from both sides by support portions 19 (heating and softening process of the resin plate 18). Next, as illustrated in FIG. 2B, the softened resin plate 18 is set (covered) on a mold 21 for vacuum forming which has a substantially projecting cross section, air between the resin plate 18 and the mold 21 is sucked as indicated by an arrow 22 from a lower side of the mold 21, and the resin plate 18 is deformed into the shape of the mold 21 along the surface of the mold 21 (molding process).

Further, although the mold 21 having the substantially projecting cross section is used in FIG. 2B, a mold having a rectangular cross section may be used to mold a protector body (C) of the protector C having a rectangular gutter shape (recessed cross section). In addition, a mold having a rectangular cross section shallower (lower) than the mold 21 illustrated in FIG. 2B may be used to mold a cover (not illustrated) having an inverted recessed cross section which closes an elliptical opening 23 of the protector body (C). Furthermore, the resin plate 18 may be heated and softened using the single-sided heater 20 rather than the upper and lower heaters.

Thereafter, as illustrated in FIG. 2C, after the molded intermediate protector workpiece 24 is cooled and hardened on the mold 21, the molded intermediate protector workpiece 24 is detached (released) upward from the mold 21 by, for example, blowing pressurized air from below between the intermediate protector workpiece 24 and the mold 21 (cooling and releasing process).

Next, as illustrated in FIG. 2D, the intermediate protector workpiece 24 is inversely upside down with FIG. 2C and is set in a lower blade die 25 (having an upward Thomson blade 26 in a trapezoid blade die body having a substantially recessed shape), an upper press plate 27 is lowered as indicated by an arrow, and unnecessary ends 24a (flange portions supported from both sides in the molding process in FIG. 2B) of the intermediate protector workpiece 24 are cut by a blade 26, thereby obtaining the protector body (C) as a produce (resin component) (trimming process). The cover of the protector C is also trimmed in a similar manner. The end material 24a cut in the trimming process is crushed into, for example, a pellet shape as described above and then is charged into the resin plate molding machine 14 illustrated in FIG. 1 to be re-used (recycled). Instead of the Thomson blade 26, a mold press may be used for trimming.

In addition, although the blades 26 are disposed at positions separated to right and left from a recessed portion 25a of the blade die body (substituted by reference numeral 25) in FIG. 2D, the blades 26 are disposed in the vicinity of the recessed portion 25a of the blade die body 25 in the case of forming, for example, the rectangular gutter-like protector body (C) or the cover (not illustrated) having an inversely recessed shape which closes the elliptical opening 23 of the protector body (C). In addition, the trimming machine 16 illustrated in FIG. 1 is not necessary in the case of easily separating the unnecessary end 24a of the molded intermediate protector workpiece 24 in a hand working manner.

Since the exclusive protector C typically includes the rectangular gutter-like protector body (C) having a bottom wall 24b (see FIG. 2D) and bilateral deep sidewalls 24c, and the cover (not illustrated) of the inverted recessed cross section having a top wall and bilateral shallow sidewalls, in one vacuum molding machine 15 illustrated in FIG. 1, the protector body and the cover are preferably molded at the same time (a protector body molding portion and a cover molding portion are provided in parallel with each other in one vacuum molding machine 15). At the end in a longitudinal direction (depth direction in FIG. 2D) of the bottom wall 24b of the protector body (C), a plate portion (not illustrated) is preferably protruded to fix a plurality of electric wires (bundle of electric wires), which are inserted into the protector body, by winding with a tape.

Furthermore, in a case where the exclusive protector C includes only the rectangular gutter-like protector body (C) having the bottom wall 24b and the bilateral deep sidewalls 24c (in the case of not using the cover), for example, after the bundle of electric wires having the plurality of electric wires (portion of the bundle of electric wires which is not wound with the tape) are inserted into the protector body, the periphery of the protector body is wound with the tape or the bundle of electric wires are wound on the above-described fixing plate portion with the tape, thereby preventing a dropout of the bundle of electric wires.

Although the vacuum molding process 4 is described in FIGS. 2A to 2D, in the case of the pressure molding process, the resin plate 18 is deformed into the shape of the mold (21) along the surface of the recessed portion of the mold (21) in such a manner of blowing downward compressed air from the top of the resin plate 18 while setting the softened resin plate 18 in FIG. 2B onto the mold (21) having a recessed shape rather than a projecting shape. Other processes (the heating and softening process of the resin plate in FIG. 2A, the cooling and releasing process of the intermediate protector workpiece in FIG. 2C, and the trimming process in FIG. 2D) are the same as in the vacuum molding.

Since the vacuum molding machine 15 or the pressure molding machine illustrated in FIG. 1 is a small desktop equipment, it can be installed in the vicinity of the wire harness assembly line 3 in the wire harness assembly plant 2 with the minimum space (for convenience of description in FIG. 1, pieces of equipment 14 to 16 such as the vacuum molding machine 15 of the vacuum molding process 4 are displayed larger than a worker 37, but have a substantially same size as the worker 37 in practice).

As illustrated in FIG. 1, the exclusive protector C manufactured by the vacuum molding process 4 or the pressure molding process is placed in a component placing yard 13 in the vicinity of component placing yards 11 and 12 of the common protectors A and B. In the component placing yards 11 to 13, the respective protectors A to C are separately disposed not to be incorporated with each other. Since the required quantity of the common protectors A and B is large and the required quantity of the exclusive protector C is small, the component placing yards 11 and 12 for the common protectors A and B are defined to be wide and the component placing yard 13 for the exclusive protector C is defined to be narrow.

Since the required number of exclusive protectors C can be timely manufactured by the vacuum molding process 4 or the pressure molding process as needed, the number of exclusive protectors C may be as small as at least one or more in the component placing yard 13. In a case where the protector body and the cover of the exclusive protector C are separated from each other (if there is no thin hinge for connection), a set of the protector body and the cover is disposed in the component placing yard 13.

The wire harness assembly line 3 includes a former electric wire laying process 28, a latter component assembly process 29, and an inspection process (appearance inspection and conduction inspection process) 30, the component placing yards 11 to 13 of the protectors A to C are located in the vicinity of the latter component assembly process 29, and a corrugated tube (protective tube), a locking clip, or a waterproof grommet which is a resin component other than the protectors A to C and is not illustrated is disposed in the vicinity of the component placing yards 11 to 13.

In FIG. 1, the vacuum molding process 4 or the pressure molding process is disposed in the vicinity of the inspection process 30 of a terminal side in the wire harness assembly line 3 as an example. In addition, the component acceptance place 9 and the component inventory placing yard 10 for the common protectors A and B are disposed on a side opposite to the vacuum molding process 4 or the pressure molding process, that is, on a left side using the component placing yards 11 to 13 as a boundary. All of the placing yards 10 and 11 to 13 may be disposed on the same side.

A wiring board 31₁ of a work start position S in the wire harness assembly line 3 is located at a right end of the wire laying process 28, a wiring board 31₁₆ of a finished product takeout position P of wire harnesses A′ to C′ (not illustrated) is located at a right end of the inspection process 30 disposed on the right side of the component assembly process 29. Each of the wiring boards (jig boards) 31 in the wire harness assembly line 3 slowly proceeds with an endless movement in a clockwise (right-handed) direction as indicated by an arrow 32.

In the wire laying process 28 of the wire harness assembly line 3, electric wires (not illustrated) are sequentially laid on a wiring fixture (not illustrated) of each of the wiring boards 31 by the worker 33 of each of the wiring boards 31. The wiring fixture (not illustrated) is also referred to as a binder and is made up of a support portion which is erected upward from the surface of the wiring board 31 and an electric wire hooking portion (binding portion) of an U-fork shape or the like which is provided at a tip of the support portion. In addition, the number of the wiring boards 31 is appropriately set as needed.

For example, a terminal is previously connected to the end of each electric wire by crimping in the preceding process, end terminals of the required electric wires are previously accommodated in a connector housing made of a synthetic resin to form a connector, and the plurality of electric wires and the connector form a sub wire harness. Wire laying of a plurality of sets of electric wires, that is, sub wire harness is completed above the wiring board 31₈ of the end (left end) of the wire laying process 28 in the wire harness assembly line 3, and thus a plurality of thin branch wires are branched in a width direction of the wiring board 31₈ from a thick main wire in a longitudinal direction of the wiring board 31₈.

The wiring board 31₈ in which the wire laying (arranging) of the electric wires has been completed is sent to the component assembly process 29, and resin components (exterior components) such as a predetermined protectors A to C, tubes, locking clips, or grommets can be assembled to a main wire or branch wires, that is, the bundle of electric wires on the wiring boards 31₁₀ to 31₁₃ in the component assembly process 29 (herein, the grommet is a rubber component, but is referred to as a resin component for convenience). The resin components including the protectors A to C are assembled to the bundle of electric wires by each worker 33 of each of the wiring boards 31₁₀ to 31₁₃. With the same manner even in the wire laying process 28, when each worker 33 finishes the given work in the wiring board 31 which has arrived at the front (holding position) of him, the worker performs the same work as in the sequent wiring board 31 without moving integrally with the wiring board 31 in the form of loop.

Each of the wiring boards 31 is attached with an identification label 34 in which identification data such as a bar code is written to indicate each product number of the wire harnesses A′ to C′ (not illustrated) to be manufactured, the worker 33 reads out the identification data of the identification label 34 using an identification data reading (capturing) apparatus 35 such as a bar code reader, and a controller (not illustrated) connected to the identification data reading apparatus 35 determines which of the resin components (for example, which of the protectors A to C) is assembled to which position of the wiring board 31, based on the read identification data and assembly setting data for each wiring board 31 which is previously input (stored) for each product number of the wire harnesses A′ to C′, so that each worker 33 of each wiring board 31 is instructed which of the resin components (for example, protectors A to C) from the component placing yards 11 to 13 or the like is preferably selected (more preferably, which of the resin components is assembled to which position of the bundle of electric wires on the wiring board 31).

That is, when the protectors A to C are described as an example, visual apparatuses 11a to 13a such as a lamp are installed in the component placing yards 11 to 13 of the common protectors A and B and the exclusive protector C, respectively. For example, worker 33 in each wiring board of the component assembly process 29 reads out (captures) the identification data of the identification label 34 in each wiring board 31 using identification data reading apparatus 35 disposed at fixed portion (immovable portions separated from the wiring boards 31) adjacent to each wiring board 31 (for convenience, the identification label 34 and the identification data reading apparatus 35 in the component assembly process 29 are illustrated at one place in FIG. 1), and a common controller (not illustrated) connected to each of the identification data reading apparatuses 35 determines, by capturing position data of the wiring board 31, which of the protectors A to C is assembled to the bundle of electric wires on the wiring board 31 and allows any of the lamps 11a to 13a of the component placing yards 11 to 13 of the protectors A to C, which will be assembled, to be turned on.

More preferably, the worker 33 is also instructed which of the protectors A to C is assembled to which position of the bundle of electric wires on any of the wiring boards 31 by a turning on a position display lamp (not illustrated) installed on the wiring board 31.

The worker 33 takes out any of the protectors A to C by hand from the component placing yards 11 to 13 in which any of the lamps 11a to 13a is turned on, reads out an assembly position of the protectors A to C from an assembly working diagram (not illustrated) previously disposed on, for example, the wiring board 31, or assembles the protectors A to C to the bundle of electric wires on the wiring board 31 in accordance to a lighting display of the position display lamp (not illustrated) installed on the wiring board 31. The identification data of the identification label 34 for each wiring board 31 is read out using each of the identification data reading apparatuses 35, so that defects such as an erroneous assembly of the protectors A to C to the bundle of electric wires or a missing component are reliably prevented.

For example, in two wiring boards 31₁₀ and 31₁₁ of the component assembly process 29, when each worker 33 reads out the identification data of each identification label 34 using each of the identification data reading apparatuses 35 at the same time and two lamps (for example, 11a and 12a) of the component placing yards 11 to 13 are turned on at the same time, it is also useful to dispose the plurality of lamps 11a to 13a in which colors corresponding to each of the wiring boards 31₁₀ and 31₁₃ are different from each other in each of the component placing yards 11 to 13 for each of the protectors A to C (for example, the lamp corresponding to the first wiring board 31₁₀ is yellow and the lamp corresponding to the second wiring board 31₁₁ is blue) to avoid a troublesome situation that any worker 33 does not know whether to take the protectors A or B instructed by any of the lamps 11a and 12a.

It is assumed that at least one exclusive protector C is constantly stocked in the component placing yard 13 such that the required number of exclusive protectors C can be produced in small quantities as needed in the wire harness assembly plant 2, for example, the lamp 13a of the component placing yard 13 of the exclusive protector C may be turned on and a lamp (visual apparatus) 36 of the molding process 4 may be simultaneously turned on. That is, the controller (not illustrated) connected to the identification data reading apparatus 35 allows the lamp 13a of the component placing yard 13 of the exclusive protector C to be turned on and simultaneously allows the lamp 36 of the molding process 4 to be turned on. An alarm apparatus (not illustrated) such as a buzzer may be used in combination.

The responsible worker 37 of the molding process 4 checks the turning-on of the lamp 36 of the molding process 4, starts the molding of the exclusive protector C, and brings the exclusive protector C to completion using the vacuum molding machine 15 and the trimming machine 16 (the resin plate 18 is preferably molded by the resin plate molding machine 14). The worker 37 places the completed exclusive protector C in the component placing yard 13 adjacent to the trimming machine 16. One exclusive protector C may be produced at a time, but a plurality (small quantities) of exclusive protectors may be collectively produced at a time. Even in either case, inventory quantities of the exclusive protectors C can be significantly reduced in the wire harness assembly plant 2 as compared with the case where the plurality of exclusive protectors C is collectively injection-molded in a conventional component plant 51 (see FIG. 3) and is carried to a wire harness assembly plant 55.

Without any stock of the exclusive protector C, for example, in a case where the worker 33 reads out the identification data of the identification label 34 for the wire harness C′ in the wiring board 31₁ at the work start position S or the next wiring board 31₂ in the wire laying process 28 of the wire harness assembly line 3 illustrated in FIG. 1 using the identification data reading apparatuses 35, if a program is previously stored in the controller (not illustrated) to instruct the molding process 4 to produce the exclusive protector C (to turn on the lamp 36 of the molding process 4), the worker 37 of the molding process 4 timely supplies the exclusive protector C to the latter component assembly process 29 by molding the exclusive protector C during working of the wire laying process 28, so that the inventory of the exclusive protector C can be set to zero.

The worker 33 of the wire laying process 28 reads out the identification data of the identification label 34 using the identification data reading apparatus 35 and can know whether the electric wires are laid at any position of the wiring board 31 by the instruction (by the turning on the lamp (not illustrated) installed on the wiring board 31) of the controller connected to the identification data reading apparatus 35.

Although the case of reading out the identification data (substituted by reference numeral 34) of the wire harnesses A′ to C′ for each wiring board 31 is described in the above embodiment as an example, selective instruction of the protectors A to C in each of the wiring boards 31₁₀ to 31₁₃ of the component assembly process 29 can be sequentially performed when the identification data of the identification label 34 of the wire harnesses A′ to C′ is read out using the identification data reading apparatus 35, for example, in the initial (first) wiring board 31₁₀ of the component assembly process 29 in the wire harness assembly line 3.

In this case, for example, switches (not illustrated) to be actuated by movement of the wiring boards 31₁₀ to 31₁₃ are provided between the wiring boards 31₁₀ to 31₁₃, respectively. When the assembly of any of the protectors A to C to the initial (first) wiring board 31₁₀ is completed and the first wiring board 31₁₀ moves to the position of the next (second) wiring board 31₁₁, the first switch is actuated, the controller (not illustrated) receiving an electric signal of the first switch allows any of the lamps 11a to 13a of the component placing yards 11 to 13 of the protectors A to C to be turned on in the second wiring board 31₁₁, and the worker 33 of the second wiring board 31₁₁ takes out any of protectors A to C from the component placing yards 11 to 13 with any of the lamps 11a to 13a turned on and assembles it to the second wiring board 31₁₁.

Then, when the second wiring board 31₁₁ moves to the position of the next (third) wiring board 31₁₂, the second switch is actuated, the controller (not illustrated) receiving an electric signal of the second switch allows any of the lamps 11a to 13a of the component placing yards 11 to 13 of the required protectors A to C to be turned on in the third wiring board 31₁₂, and so on, thereby reducing a labor of the worker 33 to read out the identification data (34) of the wire harnesses A′ to C′ using the identification data reading apparatus 35 for each of the wiring boards 31₁₀ to 31₁₃.

Even in this case, it is also useful to dispose the plurality of lamps 11a to 13a in which colors corresponding to each of the wiring boards 31₁₀ and 31₁₃ are different from each other in each of the component placing yards 11 to 13 for each of the protectors A to C. It is possible to appropriately set the timing at which the identification data (34) of the wiring board 31 is read out.

In addition, although the case of using the protectors A to C as an example is described in the above embodiment, for example, the protective tube such as a corrugated tube, the locking clip, or the waterproof grommet may be used instead of the protector. However, since the corrugated tube is formed by the combination of the extrusion molding and the vacuum molding, thereby causing the expansion of the equipment and the locking clip or the waterproof grommet is preferably formed by the injection molding, it is preferable to use the protectors A to C capable of being produced even by the injection molding 6 and the vacuum molding 4 or the pressure molding. Just like the protectors A to C which have different shapes or sizes but are the same kind, respectively, the corrugated tubes have different shapes or sizes but are the same kind, respectively, and the locking clips have different shapes or sizes but are the same kind, respectively.

A method for supplying the resin component to the wire harness assembly process according to the present invention described above will be now summarized and described.

Conventionally, the resin molding components such as the protectors A to C to be assembled to the wire harnesses A′ to C′ (not illustrated) are generally produced by the injection molding process (injection molding machine) 52 (see FIG. 3), but are intensively produced in the component plant 51 (see FIG. 3) in a batch due to expensive equipment cost or mold cost and are supplied to the wire harness assembly plant 55 (see FIG. 3). In the conventional production method, however, since the number of days required for the transport due to the physical distribution or component inventory/management is required in addition to physical distribution cost (cost of packaging 53 or transport 54), a lot of costs are generated. Accordingly, it was necessary to provide a method for manufacturing protectors and a process of manufacturing wire harnesses for the purpose of reducing the physical distribution cost and expense and lowering the cost of the components A to C, and particularly, to provide a method for supplying resin components to a wire harness assembly process.

Herein, the present invention is to rationalize component cost or a molding method for the resin molding components such as the protectors A to C and a process of manufacturing the wire harnesses A′ to C′ (not illustrated) in the wire harness assembly plant 2 (see FIG. 1).

The wire harnesses A′ to C′ are manufactured based on production planning and are different in product number of the wire harnesses A′ to C′ by destination (North America, China, Japan, or the like), a grade of vehicle, presence or absence of an optional equipment or the like. For example, when the manufacture of the wire harnesses A′ to C′ is repetition production of numbers A′A′A′A′→B′B′B′→C′, the protectors (resin molding components) A and B of a vehicle common component or the like which have a lot quantity of production and are assembled to the wire harnesses A′ and B′ are intensively produced in the component plant 1 as in the past and then are conveyed and supplied to the wire harness assembly plant 2, in FIG. 1.

The protector (resin molding component) C of a vehicle exclusive component or the like which has a small quantity of production and is assembled only to the wire harness C′ is manufactured inside the wire harness assembly plant 2 or at the wire harness assembly line 3 side. Herein, a method for molding the resin molding component C employs the vacuum molding process 4 or the pressure molding process. However, a small-sized injection molding machine (not illustrated) can be used depending on the product shape (for example, the case where the shape is complicated) or the production quantity (for example, the case where the production quantity is lot) of the resin molding component C.

The worker 33 of the component assembly process 29 in the wire harness assembly line 3 selects a molding component including the protectors A to C suitable to the production number of the wire harness based on the production planning of the wire harnesses A′ to C′ and completes the assembly by assembling the molding component to the wire harnesses A′ to C′. A method for selecting the component is performed in such a manner that the worker 33 reads out the identification data of the bar code or the like of the identification label 34 and the product number of the wire harness using the identification data reading apparatus (recognition apparatus) 35 at the stage of assembling the molding component including the protectors A to C in component assembly process 29 and thus is informed of the assembly component including the protectors A to C suitable to the product number by the visual apparatus such as the lamps 11a to 13a of the component placing yards 11 to 13.

For example, the lamp 11a of the component placing yard 11 of the component A is turned on in the case of the wire harness A′, the lamp 12a of the component placing yard 12 of the component B is turned on in the case of the wire harness B′, and the lamp 13a of the component placing yard 13 of the component C is turned on in the case of the wire harness C′, so that the worker 33 reliably takes out the required components (for example, protectors A to C) from the component placing yards 11 to 13 without mistaking in accordance with instructions of the lamps 11a to 13a.

Further, for example, it is possible to place all kinds of assembling components including the protector A for the wire harness A′ in the component placing yard 11 of the component A in a batch. In this case, each worker 33 of the component assembly process 29 preferably takes out all kinds of assembling components including the protector A from the component placing yard 11 at the same time and assembles it to the wire harness A′ in order of an assembly instruction diagram on the wiring board 31 while looking at the diagram, for example.

In addition, for example, in the case where product and shape of the exclusive component (protector) C to be assembled to the wire harness C′ are obviously different from those of other components (protectors) A and B, it is possible to select the component C only by a visual determination of the worker without displaying the lamp of the component placing yard 13.

In addition, since the exclusive component (protector) C is manufactured inside the wire harness assembly plant 2 or at the wire harness assembly line 3 side, the worker 37 of the molding process 4 is informed of the manufacture start based on the production planning by the lamp (visual) 36 or the buzzer (hearing) to manufacture only a required amount as needed.

The unnecessary end material 24a (see FIGS. 2A to 2D) caused by the trimming 16 of the vacuum molding process 4 or the pressure molding process is used as a recycling material in the vacuum molding process 4 or the pressure molding process. The resin plate 18 (see FIGS. 2A to 2D) to be used as a molding material of the vacuum molding 15 or the pressure molding is assumed to be produced in the wire harness assembly plant 2 or at the wire harness assembly line 3 side, but can be a production consignment product or a purchase product according to the production quantity or the production base.

Two kinds of common protectors A and B and one kind of exclusive protector C are described in the above embodiment as an example, but the present invention is not limited thereto and three or more kinds of common protectors and two or more kinds of exclusive protectors are also applicable to the present invention. Kinds of wire harnesses are not also limited to three kinds of A′ to C′ described above, but may be four or more kinds.

According to the present invention, the resin components A to C are optimally supplied by properly using the component molding method, that is, the injection molding 6 and the vacuum molding 4 or the pressure molding, and the component cost is reduced by the reduction of the physical distribution cost or the wasteful expense. In addition, an unnecessary inventory 57 (see FIG. 3) is reduced by the wire harness manufacturing process synchronized with the production of the wire harnesses A′ to C′. In addition, the cost of physical distributions 53 and 54 (see FIG. 3) or the cost of component managements 56 and 57 is reduced and the component C is stably supplied by the production of the exclusive component C at the wire harness assembly line 3 side. Furthermore, it is possible to smoothly cope with the fluctuation of the production quantity or the transfer of the production base by the manufacture of the component C due to the vacuum molding 15 or the pressure molding in the small-sized equipment.

### INDUSTRIAL APPLICABILITY

The method for supplying the resin components to the wire harness assembly process according to the present invention can be used to suppress the increase of the production cost of the wire harness caused by the less frequently used resin component and to reduce the cost of the wire harness in the wire harness assembly plant, for example, in the case where there are the more frequently used resin components which are mutually used in the wire harness of each type of vehicles and the less frequently used resin component which is exclusively used in the wire harness of a particular type of vehicle.

### REFERENCE SIGNS LIST

A, B: more frequently used protector (resin component)
C: less frequently used protector (resin component)
1: component plant
2: wire harness assembly plant
3: wire harness assembly line
4: vacuum molding process (molding process)
6: injection molding process (molding process)
11 to 13: component placing yard
11a to 13a: lamp (visual display)
14: resin plate molding machine
15: vacuum molding machine
16: trimming machine
24a: end material
34: identification label (identification data)
35: identification data reading apparatus
36: lamp (visual display)

1. A method for supplying resin components to a wire harness assembly process comprising:
producing more frequently used resin components of the same kinds of resin components to be assembled according to product numbers of wire harnesses using a molding process in a component plant, thereby being carried into a wire harness assembly plant;
producing less frequently used resin components of the same kinds of resin components to be assembled according to the product numbers of wire harnesses using the molding process in the wire harness assembly plant; and
appropriately supplying the more frequently used resin components and the less frequently used resin components to a wire harness assembly line of the wire harness assembly plant.

2. The method for supplying the resin components to the wire harness assembly process according to claim 1, wherein the more frequently used resin components are produced using an injection molding process and the less frequently used resin components are produced using a vacuum molding process or a pressure molding process.

3. The method for supplying the resin components to the wire harness assembly process according to claim 1, wherein the more frequently used resin components and the less frequently used resin components are disposed in each component placing yard of the wire harness assembly plant, and
an identification data of a wire harness to be assembled is read out using an identification data reading apparatus in the wire harness assembly line, thereby visually displaying a component placing yard of a resin component required for an assembly and visually displaying the molding process in the wire harness assembly plant when the less frequently used resin component is required.

4. The method for supplying the resin components to the wire harness assembly process according to claim 2, wherein the more frequently used resin components and the less frequently used resin components are disposed in each component placing yard of the wire harness assembly plant, and
an identification data of a wire harness to be assembled is read out using an identification data reading apparatus in the wire harness assembly line, thereby visually displaying a component placing yard of a resin component required for an assembly and visually displaying the molding process in the wire harness assembly plant when the less frequently used resin component is required.

5. The method for supplying the resin components to the wire harness assembly process according to any of claim 1, wherein the molding process in the wire harness assembly plant is constituted by a resin plate molding machine, a trimming machine, and a vacuum molding machine or a pressure molding machine, and
an end material that occurred in the trimming machine is recycled in the resin plate molding machine.

6. The method for supplying the resin components to the wire harness assembly process according to any of claim 2, wherein the molding process in the wire harness assembly plant is constituted by a resin plate molding machine, a trimming machine, and a vacuum molding machine or a pressure molding machine, and
an end material that occurred in the trimming machine is recycled in the resin plate molding machine.

7. The method for supplying the resin components to the wire harness assembly process according to any of claim 3, wherein the molding process in the wire harness assembly plant is constituted by a resin plate molding machine, a trimming machine, and a vacuum molding machine or a pressure molding machine, and
an end material that occurred in the trimming machine is recycled in the resin plate molding machine.

8. The method for supplying the resin components to the wire harness assembly process according to any of claim 4, wherein the molding process in the wire harness assembly plant is constituted by a resin plate molding machine, a trimming machine, and a vacuum molding machine or a pressure molding machine, and
an end material that occurred in the trimming machine is recycled in the resin plate molding machine.
